(19) United States
(12) Patent Application Publication
(10) Pub. No.: US 2007/0236098 A1
(43) Pub. Date: Oct. 11, 2007

(54) Vehicle alternator

(75) Inventors: Shin Kusase, Oobu-shi (JP); Akiya Shichijoh, Ama-gun (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/700,882

(22) Filed: Feb. 1, 2007

(30) Foreign Application Priority Data
Apr. 10, 2006 (JP) 2006-107580

(51) Int. Cl. H02K 16/02; H02K 1/22

(52) U.S. Cl. 310/263; 310/114

(57) ABSTRACT

A tandem vehicle alternator has dual electrical power generation units. Each generation unit has a Lundel type rotor core and a stator coil. The Lundel type rotor cores are arranged in a tandem arrangement in the vehicle alternator. Each stator coil is composed of sequential segment joining type stator coils. A center position of an inside disk part in a pair of disk parts, placed at the outside of the rotor core, is positioned within a width of an armature iron core as a stator core. This configuration enlarges a gap between inner coil ends faced to each other in the adjacent stator coils at the inside in the axis direction, cools those inner coil ends, and reduces a mutual inductance generated between the inner coil ends. The feature improves the output of the vehicle alternator and enhances the independent control of each generation unit.

### CROSS-REFERENCE TO RELATED APPLICATIONS

This application is related to and claims priority from Japanese Patent Application No. 2006-107580 filed on Apr. 10, 2006, the contents of which are hereby incorporated by reference.

### BACKGROUND OF THE INVENTION

1. Field of the Invention

The present invention relates to a vehicle alternator or a vehicular AC electric generator with improved installation capability for a vehicle.

2. Description of the Related Art

Generally, vehicles are being designed with smaller engine compartments in order to provide greater interior space. As a result, there is increasingly less space available for mounting vehicle alternators within vehicle engine compartments. The demand for increasingly higher power outputs of vehicle alternators are increasingly greater because of the increased electrical loads created by controllers of safety features and plural electrical loads. A small high-power and low-cost vehicle alternator is in great demand. There is further a strong demand of supplying plural electric voltages in a vehicle according to the recent diversification of electric devices as electric loads mounted on a vehicle. One conventional technique has been proposed, in which two different vehicle alternators are mounted near an engine. However, it is difficult to mount the two different vehicle alternators, in particular, horizontal vehicle alternators to be placed horizontally, on a space closed to the engine of the vehicle in view of the allowance of deformation caused by crash accident. In order to the above difficulty, another conventional technique has been proposed, in which a pair of electric power generators or dual electric power generators, each comprising a stator and a rotor, are placed along its axis direction in a housing of the vehicle alternator. The vehicle alternator of this type is called to as “a tandem electric rotary machine” or “a tandem vehicle alternator”. For example, a Japanese patent laid open publication No. JP S57-42565 . . . (1) has disclosed such a tandem vehicle alternator.

Japanese patent laid open publication (1) shows a tandem vehicle alternator equipped with a pair of electric power generators placed along its axis direction in the housing of the vehicle alternator. Each electric power generator is composed mainly of a stator and a rotor.

However, the tandem vehicle alternator of such a conventional configuration has a problem of interacting the vehicle alternator with a lateral exhaust pipe and an inlet pipe mounted near the vehicle alternator because the tandem vehicle alternator has an extended effective length in a longitudinal direction thereof when compared with the size of an ordinary vehicle alternator. Thus, there are various difficult problems to be solved for adapting the tandem vehicle alternator to various applications.

In order to solve the conventional problems described above, the applicant according to the present invention has proposed a tandem vehicle alternator equipped with an armature winding as a stator coil that is composed mainly of a plurality of letter-U-shaped segment electrical conductors sequentially connected (hereinafter, referred to as “a sequential segment joining type stator coil”). In the configuration of the stator coil composed of a plurality of letter-U-shaped segment electrical conductors, a pair of leg parts (or a pair of end parts) of each letter U shaped segment electrical conductor are inserted independently from one side of an axis direction into a pair of slots that are separated to each other by a magnet pole pitch. A pair of the coil ends of the armature winding is formed by each leg part of the letter-U-shaped segment electrical conductor extruded toward the other side of the axis direction. The sequential segment joining type stator coil of this type is widely known and disclosed by following Japanese patent documents (2) to (4), for example.
(2) Japanese patent No. 3118837;
(3) Japanese patent No. 3178468; and
(4) Japanese patent No. 3199068.

The sequential segment joining type stator coil is capable of reducing the length of a coil end in the axis direction when compared with the length of an ordinary stator coil. Accordingly, applying the sequential segment joining type stator coil to the tandem vehicle alternator can make a vehicle alternator of a practical size in the axis direction because the size of the vehicle alternator is determined by a total length of both armatures placed in series along the axis direction and the tandem vehicle alternator can obtain twice the effect of reducing the length of the coil end when compared with the ordinary vehicle alternator. In other words, the conventional tandem vehicle alternator well known has a practical length in the axis direction for the first time when it uses only the sequential segment joining type stator coil.

However, the applicants according to the present invention have found a following problem involved in a tandem vehicle alternator adopting the sequential segment joining type stator coil (hereinafter, referred to as “a segment coil type tandem vehicle alternator”). That is, the length of a tandem vehicle alternator in the axial direction thereof is determined by a sum of a length of a pair of armatures placed in a tandem arrangement in an axis direction and a length of a rotor structure including a pair of Lundel field windings placed in a tandem arrangement in its axis direction. That is, even if the total length of a pair of the armatures is reduced in the axis direction by using the sequential segment joining type stator coils, it is still difficult to reduce the length of the tandem vehicle alternator in the axis direction unless the length of the rotor structure is reduced in the axis direction.

In the description described above, the rotor includes a Lundel field winding and a pair of bearings placed at the both ends of the field winding. Cooling fans are further placed at both ends of the Lundel field winding in the axis direction and both the cooling funs are separated from the axis of the Lundel field winding by an approximate same distance. That is, even if the total length of a pair of the armatures is reduced by using the sequential segment joining type stator coils, it is still difficult to reduce the total length of the tandem vehicle alternator in the axis direction because of the difficulty of reducing the length of the rotor structure in the axis direction.

The conventional tandem vehicle alternator further involves various problems because of the close arrangement of a pair of the armatures in the axis direction.

A first problem is difficulty of supplying cooling air to a pair of coil ends (also referred to as “an inner side coil end) extended and faced to each other, namely, closely placed between a pair of armature iron cores. This causes a temperature rise of the coil ends. That is, in an ordinary vehicle alternator (having a single armature core, not a tandem vehicle alternator), the cooling fan efficiently cools the coil end of the stator windings because both coil ends are placed at the outside of the cooling funs of the rotor structure in the radius direction. On the contrary, in the conventional tandem vehicle alternator, it is difficult to place cooling funs capable of cooling the inner coil end placed at the inner part in the radius direction and also difficult to supply the cooling air to the inner coil end.

A second problem is that a three-phase AC current is induced in one armature coil wound on a pair of the armature iron cores by a three-phase AC current flowing through the other armature coil because of an inductance generated between the both inner coil ends in a pair of the stators that are closely placed to each other. This induced three-phase AC current deteriorates the independent controlling of each electric power generation unit.

### SUMMARY OF THE INVENTION

It is an object of the present invention to provide an improved vehicle alternator having a reduced length in its axis direction capable of reducing temperature rise of armature coils wound around a pair of armature iron cores, and also capable of efficiently performing the independent controlling for each of electric power generation units.

To achieve the above purposes, the present invention provides a vehicle alternator having a pair of electric power generation units (or dual electric generators) adjacently placed along its axis direction in a tandem arrangement. Each electric power generation unit has an armature and a Lundel type field winding. Each Lundel type field winding forms a tandem type rotor. A pair of the Lundel type field windings is fixed to a same rotary shaft of the vehicle alternator.

Each Lundel type field winding has a boss part and a pair of disk parts. The boss part is composed of a cylindrical iron core fixed to the rotary shaft of the vehicle alternator. A field winding is wound on an outer surface of the boss part. A pair of the disk parts is faced to each other and each disk part is composed of a ring plate iron core extending from an end of the boss part toward an outside direction in the radius direction. An even number of claw poles are alternately faced to each other and extend toward the axis direction from an outer end part of each disk part in the radius direction, and alternately form a north pole and a south pole. The armature has a cylindrical armature iron core fixed to a housing of the vehicle alternator. An armature winding is wound around the cylindrical armature iron core which is placed at the outside of the claw poles along the radius direction in the vehicle alternator. The armature winding is composed of plural letter-U-shaped electrical conductors. Each conductor is inserted through one side of a pair of slots arranged in the axis direction and sequentially connected to each other.

In the vehicle alternator, one disk part in a pair of the disk parts forms an inside disk part, and a center position of the inside disk part observed from the axial direction is placed within a width of the cylindrical armature iron core observed from the axial direction of the cylindrical armature iron core, and the inside disk part of each electric power generation unit is placed at the outside of the axis of the tandem type rotor.

The present invention uses the feature of a tandem vehicle alternator which uses plural sequential segment joining type stator coils forming an armature iron core as a stator core that has a shorter length of each coil end when compared with a length of each coil end in an ordinary vehicle alternator which does not use the sequential segment joining type stator coils. In view of the above feature of the sequential segment joining type stator coils, each armature in a pair of the armatures is shifted toward the outside in the axis direction to the position of each corresponding Lundel type field winding. It is thereby possible to keep a large gap between the coil ends, faced to each other, in a pair of the armature iron cores.

In addition, because the axial length of the vehicle alternator is determined in general by the size of the entire structure of the rotors composed of a pair of the Lundel type field windings, the use of the sequential segment joining type stator coils can prevent the increase of the totally axial length of the armature iron cores even if a pair of the armatures are separated to each other in position toward the axial direction.

Still further, because a large gap is obtained between the coil ends of a pair of the armatures faced to each other in the axis direction, it is easily possible to cool a pair of the coil ends, and to prevent the thermal interact between those coil ends whose temperature become high during operation. Still further, because the magnitude of an induced voltage between a pair of the coil ends under the electromagnetic coupling can be reduced, it is thereby possible to improve the control capability of a pair of the electric power generation units.

In accordance with another aspect of the present invention, there is provided the vehicle alternator in which the other disk part in a pair of the disk parts is an outside disk part. The center of the outside disk part is placed in the axis direction at the outside of the width of the cylindrical armature iron core, observed from its axial direction, placed at the inside of the axis of the tandem type rotor. Because the outside disk part is shifted to the outside from the inside space area being in the radius direction of the cylindrical armature iron core, it is possible to enlarge the placement space for the field coil in the Lundel type field winding (rotor), and it is further possible to keep the gap of an adequate length between both of the coil ends in a pair of the armatures, adjacently faced to each other, at the inside of a pair of the armatures in the axis direction.

In accordance with another aspect of the present invention, there is provided the vehicle alternator in which a permanent magnet is placed in a gap along the circumference direction between the claw pole extending from the inside disk part and the claw pole extending from the outside disk part. The permanent magnet is magnetized in order to enhance a magnetic force of the claw pole. This configuration increases the output of the vehicle alternator.

For a more detailed explanation, in a pair of the armatures is shifted in the axis direction, the claw poles extending from the outside disk part and also placed at the outside of the inside disk part in the radius direction are overlapped in the axis direction to the corresponding inside disk part. The claw poles extending from the outside disk part are faced to the surface of the inside disk part in addition to the claw poles of the inside disk part adjacent to the outside disk part by a specified gap along the circumferential direction. This configuration causes the magnetic flux leakage and also increases the amount of the magnetic flux leakage and thereby decreases the output of the vehicle alternator. In order to avoid this drawback, the vehicle alternator having the tandem configuration according to the present invention incorporates the permanent magnets. Each permanent magnet is placed in the gap between the adjacent claw poles along the circumferential direction, and each permanent magnet is magnetized in the direction in order to enhance the magnetic field of each claw pole. This configuration of the Lundel type field windings can reduce the amount of the magnetic flux leakage and thereby increases the output of the vehicle alternator.

It is preferred that each permanent magnet is overlapped in the axis direction to the inside disk part. It is thereby possible to prevent the magnetic flux leakage generated between the inside disk part and the claw poles formed on the corresponding outside disk part.

In accordance with another aspect of the present invention, there is provided the vehicle alternator in which a width of a front tip end surface of each tooth along the circumferential direction at the inside in the radius direction of the cylindrical armature iron core is narrower than a width of the permanent magnet along the circumferential direction. This configuration enables to reduce the amount of the magnetic flux leakage at a front tooth in which the magnetic flux flows out through the front end tip part of the tooth at the radius direction, and thereby increase the output of the vehicle alternator by the amount of the magnetic flux leakage.

In accordance with another aspect of the present invention, there is provided the vehicle alternator in which each phase has a plurality of the slots in the cylindrical armature iron core. This configuration enables to reduce the magnetic resistance of the magnet circuit of the armature iron core and also to keep the saturation amount of the magnetic flux of the armature iron core because the number of slots per pole and per phase is increased, in other words, the number of teeth per pole and per phase is increased even if the front end tip surface of each tooth at the inside in the radius direction of the armature is reduced. As a result, it is possible to prevent the decrease of the output caused by increasing the amount of the magnetic resistance in the magnet circuit of the armature side.

In accordance with another aspect of the present invention, there is provided the vehicle alternator in which plural line-shaped concave grooves are formed at a specified pitch on an outer circumferential surface of each claw pole. This configuration enables to reduce the amount of an eddy current generated at the front end tip surface of each claw pole at the inside of the radius direction. It is preferred that the depth of each line-shaped concave groove is approximately equal to the gap length between the stator core (as the armature iron core) and the claw poles. However, it is also acceptable to have the depth of each line-shaped concave groove within a range unless the flow of the field magnetic flux is not prevented. It is preferred to decrease the width of each line-shaped concave groove as narrow as possible in order to prevent the amount of the magnetic flux flowing from the claw poles to the teeth. It is also preferred to reduce the pitch of the line-shaped concave grooves than the width of the tooth of the stator core along the circumferential direction. This can enhance the effect obtained by extending the flow path of the eddy current and achieve the increase of the output of the vehicle alternator. That is, it is possible to effectively prevent the eddy current loss at the front tip end part of the teeth at the inside in the radius direction of the armature to be caused by the additional permanent magnets and by increasing the number of the teeth. It is thereby possible to prevent the temperature rise of the field coils.

In accordance with another aspect of the present invention, there is provided the vehicle alternator having a Lundel type field winding and an armature. In the vehicle alternator, the Lundel type field winding has a boss part, a pair of disk parts, and an even number of claw poles. The boss part is composed of a cylindrical iron core fixed to a rotary shaft of the vehicle alternator. A field winding is wound around an outer surface of the boss part. A pair of the disk parts is faced to each other. Each disk part is composed of a ring plate iron core extending from an end of the boss part toward an outside direction in the radius direction. The even number of claw poles are faced to each other and extend toward the axis direction from an outer end part of each disk part placed in the radius direction and alternately form a north pole and a south pole.

The armature has a cylindrical armature iron core fixed to a housing of the vehicle alternator. An armature winding is wound around the cylindrical armature iron core and is placed at the outside of the claw poles along the radius direction.

The Lundel type field winding further has permanent magnets magnetized in order to enhance a magnetic force of each claw pole. Each of the permanent magnets is placed at a gap between the claw poles adjacent to each other in the circumferential direction. At least one of a pair of the disk parts forms an inside disk part. A center position of the inside disk part observed from the axial direction is placed within a width of the cylindrical armature iron core observed from the axial direction of the cylindrical armature iron core.

The present invention has an improved feature in which the center position of at least one disk part in a pair of the disk parts of the Lundel type field iron core in the axis direction is shifted toward the inside position of the end surface of the armature iron core in the axis direction. On the contrary, in a conventional Lundel type vehicle alternator, a center position of the disk part in the axis direction is placed at the outside of the end surface of the armature iron core in the axis direction. This is the reason why the disk part becomes close to the claw poles of the other disk part and the magnetic flux leakage is also increased, and as a result, the output of the vehicle alternator is thereby decreased if the center position of the one disk part in the axis direction is placed at the inside of the end surface of the armature iron core in the axis direction.

On the contrary, according to the present invention, each permanent magnet is placed in the gap between the adjacent claw poles faced to each other along the circumferential direction and each permanent magnet is magnetized in the direction in order to enhance the magnetic field of each claw pole. This configuration enables to reduce the length of the Lundel type field iron core in the axis direction while preventing the leakage of the field magnetic flux of the claw poles into the inside disk part even if the claw poles are placed at the outside of the disk part in the radius direction when the center position of the disk part of the Lundel type field iron core is placed at the inside of the armature iron core in the radius direction.

For more detailed explanation, when the claw poles are overlapped in the axis direction to the inside disk part and positioned at the outside in the radius direction of the inside disk part, the claw poles extending form the other disk part (namely, from the outside disk part) are faced to the surface of the inside disk part in addition to the claw poles of the adjacent inside disk part in the circumferential direction separated by a specified gap. This causes a lot of the magnet flux leakage and thereby reduces the output of the vehicle alternator when compared with an ordinary Lundel type field winding. This drawback can be drastically prevented and eliminated by incorporating the permanent magnets between the claw poles in the inside disk part and the outside disk part. It is preferred to place those permanent magnets so that each permanent magnet is overlapped in the axis direction to the inside disk part. It is thereby possible to efficiently suppress the magnetic flux leakage caused between the inside disk part and the claw poles of the outside disk part.

In accordance with another aspect of the present invention, there is provided the vehicle alternator in which the armature winding is composed of plural letter-U-shaped electrical conductors and each conductor is inserted through one side of a pair of slots arranged in the axis direction and sequentially connected to each other.

Even if the length of the Lundel type field iron core is reduced in the axis direction, the effect to reduce the entire length of the vehicle alternator is limited when the length of the coil end of the armature is long in the axis direction like the length of a coil end of a conventional vehicle alternator. In order to avoid this drawback, the present invention adopts the coil end of a shorter length in the axis direction composed of the plural letter-U-shaped electrical conductors. This configuration can realize reducing both of the length of the Lundel type field iron core in the axis direction and the length of the armature in the axis direction simultaneously, and as a result, it is possible to reduce the entire length of the vehicle alternator in the axis direction.

In accordance with another aspect of the present invention, there is provided the vehicle alternator in which each permanent magnet is placed extending toward the outside of the inside disk part in the radius direction. It is thereby possible to efficiently reduce the magnetic flux leakage between the inside disk part and the front end tip part of the claw poles extending to the outside area of the inside disk part in the radius direction.

In accordance with another aspect of the present invention, there is provided the vehicle alternator in which a center position of the outside disk part as the other disk part in a pair of the disk parts is within a width of the cylindrical armature iron core observed from the axial direction of the cylindrical armature iron core. It is thereby possible to increase twice or more the reduction effect of the Lundel type field iron core in the axis direction.

In accordance with another aspect of the present invention, it is so formed that a width of a front tip end surface of each tooth along the circumferential direction at the inside of the cylindrical armature iron core in the radius direction is narrower than a width of the permanent magnet along the circumferential direction. This configuration enables to reduce the amount of the magnetic flux leakage at a front tooth in which the magnetic flux flows out through the front end tip part of the tooth at the radius direction when the front tip end surface of each tooth of the armature iron core at the inside in the radius direction intersects the placement area of the permanent magnets in the circumference direction, and thereby increase the output of the vehicle alternator by the amount of the magnetic flux leakage.

In accordance with another aspect of the present invention, there is provided the vehicle alternator in which each phase has a plurality of the slots in the cylindrical armature iron core. This configuration enables to reduce the magnetic resistance of the magnet circuit of the armature iron core and also to keep the amount of magnetic saturation of the armature iron core because the number of slots per pole and per phase, in other words, the number of teeth per pole and per phase is increased even if the front end tip surface of each tooth at the inside in the radius direction of the armature. As a result, it is possible to prevent the decrease of the output caused by increasing the amount of the magnetic resistance in the magnet circuit of the armature side.

In accordance with another aspect of the present invention, there is provided the vehicle alternator in which plural line-shaped concave grooves are formed at a specified pitch on an outer circumferential surface of each claw pole. This configuration enables to reduce the amount of an eddy current generated at the front end tip surface of each claw pole at the inside of the radius direction. It is preferred that the depth of each line-shaped concave groove has a depth narrower than the gap length between the stator core (as the armature iron core) and the claw poles. It is also preferred to form the line-shaped concave grooves at a specified pitch that is smaller than the width of the tooth of the stator core in the circumferential direction at the most inside area in the radius direction. The line-shaped concave grooves are formed in the direction so as to extend the eddy current path generated in the surface of each claw pole according to the change of the magnetic flux of the teeth of the armature iron core. This can increase the output of the vehicle alternator. That is, it is possible to effectively prevent the eddy current loss at the front tip end part of the teeth at the inside in the radius direction of the armature to be caused by the additional permanent magnets and by increasing the number of the teeth. It is thereby possible to prevent the temperature rise of the field coils.

### BRIEF DESCRIPTION OF THE DRAWINGS

A preferred, non-limiting embodiment of the present invention will be described by way of example with reference to the accompanying drawings, in which:

FIG. 1 is a sectional view showing a configuration of a tandem vehicle alternator equipped with dual electric power generation units placed in an axis direction according to a first embodiment of the present invention;

FIG. 2 is a sectional view mainly showing an electric power generation unit in the tandem vehicle alternator shown in FIG. 1;

FIG. 3 is a partial extended elevation of one Lundel rotor core in the tandem vehicle alternator shown in FIG. 1;

FIG. 4A is a partial extended elevation of one stator core in the tandem vehicle alternator shown in FIG. 1;

FIG. 4B is a partial extended elevation of the other stator core in the tandem vehicle alternator shown in FIG. 1;

FIG. 5A is a partial extended elevation of one stator core in a comparative example;

FIG. 5B is a partial extended elevation of the other stator core in the comparative example;

FIG. 6A is a view showing a modified example of the stator core in the vehicle alternator shown in FIG. 1;

FIG. 6B is a view showing a modified example of the stator core in the vehicle alternator shown in FIG. 1;

FIG. 7 is a view showing an example of line-shaped grooves formed on the surface of each claw pole in the tandem vehicle alternator shown in FIG. 1;

FIG. 8 is a schematic sectional view of the vehicle alternator equipped with a single electric power generation unit according to the second embodiment of the present invention; and

FIG. 9 is a partial extended elevation of a Lundel rotor core in the vehicle alternator shown in FIG. 8.

### DETAILED DESCRIPTION OF THE PREFERRED EMBODIMENTS

Hereinafter, various embodiments of the tandem vehicle alternator using a segment coil according to the present invention will be described with reference to the accompanying drawings. In the following description of the various embodiments, like reference characters or numerals designate like or equivalent component parts throughout the several diagrams.

### First Embodiment

### (Entire Configuration)

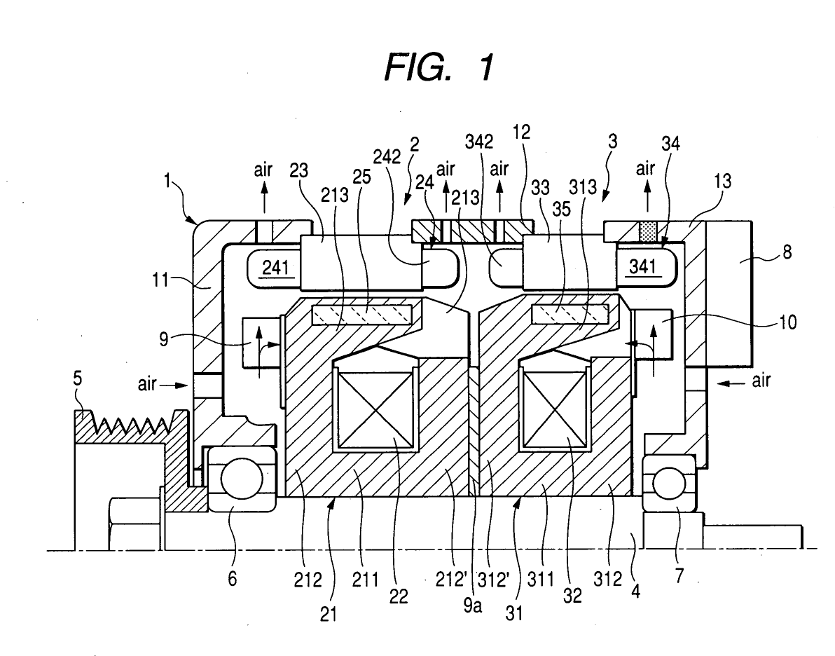

A description will be given of the configuration and action of the segment coil type tandem vehicle alternator according to the first embodiment with reference to FIG. 1.

FIG. 1 is a sectional view showing a configuration of the tandem vehicle alternator having dual electric power generation units placed in an axis direction according to the first embodiment of the present invention.

The tandem vehicle alternator shown in FIG. 1 has a housing 1, a primary rotary electric machine section 2, a secondary rotary electric machine section 3, a rotor shaft 4, a pulley 5, bearings 6 and 7, a circuit device 8 composed of various apparatus such as a rectifier and a regulator, a front side cooling fan 9, and a rear side cooling fan 10.

The housing 1 is composed of a front housing 11, a center housing 12, and a rear housing 13. Those housing components 11, 12, and 13 of the housing 1 are fixed tightly together by through bolts (not shown).

The rotor shaft 4 is supported to the housing 1 through the bearings 6 and 7. The pulley 5 is fixed to the front end part of the rotor shaft 4 that protrudes from the front end surface of the housing 1. The circuit device 8 including the rectifier and the regulator and the like is fixed to the outer circumferential part of the rear housing 13.

The primary rotary electric machine 2 is composed mainly of a Lundel type rotor core 21, a Lundel type field winding, a stator core 23, and an armature. The Lundel type rotor core 21 is made of soft metal. The Lundel type field winding is composed of a field coil 22 wound around the Lundel type rotor core 21. The stator core 23 is arranged at the outside part of the Lundel type rotor core 21 in the radius direction. The armature is composed of the stator coil 24 wound around the stator core 23.

The Lundel type rotor core, namely a Lundel type field core 21 is composed of a boss part 211, a pair of disk parts 212 and 212′, and even number of claw poles 213. The boss part 211 is made of a cylindrical shaped iron core tightly connected to the rotary shaft 4. Each of the disk parts 212 and 212′ is made of ring-shaped iron cores extending outward the radius direction from both ends of the boss part 211. The plural claw poles 213 alternately forming the North poles and the South poles faced to each other in a circumference direction are extended from the outer periphery surface (or the outer end part in the radius direction) of both the disk parts 212 and 212′ toward the axis direction. The Lundel type rotor core 21 is composed of a pair of half cores in which the boss parts 211 of the half cores are faced to each other in the axis direction. The field coil 22 is wound around each boss part 211 of the Lundel type rotor core 21. The stator core 23 is made of cylindrical shaped magnetic steel and placed between the front housing 11 and the center housing 12 in the axis direction. The stator coil 24 is made of the sequential segment joining type stator coils wound around the stator core 23.

The secondary rotary electric machine 3 is composed mainly of a Lundel type rotor core 31, a Lundel type field winding, a stator core 33, and an armature. The Lundel type rotor core 31 is made of soft metal. The Lundel type field winding is composed of a field coil 32 wound around the Lundel type rotor core 31. The stator core 33 is arranged at the outside part of the Lundel type rotor core 21 in the radius direction. The armature is composed of the stator coil 34 wound around the stator core 33.

The Lundel type rotor core (as a Lundel type field core) 31 is composed of a boss part 311, a pair of disk parts 312 and 312′, and even number of claw poles 313. The boss part 311 is made of a cylindrical shaped iron core tightly connected to the rotary shaft 4. Each of the disk parts 312 and 312′ is made of ring-shaped iron cores extending outward the radius direction from both ends of the boss part 311. The plural claw poles 313 alternately forming a north pole and a south pole faced to each other in a circumference direction are extended from the outer periphery surface (or the outer end part in the radius direction) of both the disk parts 312 and 312′ toward the axis direction. The Lundel type rotor core 31 is composed of a pair of half cores in which the boss parts 311 of the half cores are faced to each other in the axis direction. The field coil 32 is wound around each boss part 311 of the Lundel type rotor core 31. The stator core 33 is made of cylindrical shaped magnetic steel and placed between the center housing 12 and the rear housing 13 in the axis direction. The stator coil 34 is made of the sequential segment joining type stator coils wound around the stator core 33.

Each of the primary rotary electric machine 2 and the secondary rotary electric machine 3 described above is a rotary electric machine equipped with a typical Lundel type rotor core. Because the other components of each of the primary rotary electric machine 2 and the secondary rotary electric machine 3 have the same configurations of those of an ordinary Lundel type rotor core, the explanation for those components is omitted here.

Although other components such as slip rings and brushes are mounted at the rear end part of the rotary shaft 4, those components are omitted from the drawing.

A cylindrical spacer 9a of a non-magnetic material is placed between the outside disk part 212′ of the rotor core 21 and the outside disk part 312′ of the rotor core 31. In the embodiments of the present invention, the cylindrical spacer 9a is made of a copper ring plate through which thermal energy is transferred between the rotor core 21 and the rotor core 31.

Each of the front cooling fan 9 and the rear cooling fan 10 has a centrifugal cooling fan. The front cooling fan 9 is fixed to the claw pole 213 at the front side of the rotor core 21 and the rear cooling fan 10 is fixed to the claw pole 313 at the rear side of the rotor core 31.

The front cooling fan 9 induces a cooling air through an inlet hole at the front side wall of the front housing 11, and accelerates the induced cooling air, and then outputs the accelerated cooling air to the coil end 214 through outlet holes formed on the circumferential wall of the front housing 11 in order to cool the coil end 214 of the stator coil 24. The front cooling fan 10 induces a cooling air through an inlet hole at the rear side wall of the rear housing 13, and accelerates the induced cooling air, and then outputs the accelerated cooling air toward the coil end 314 through outlet holes formed on the circumferential wall of the rear housing 13 in order to cool the coil end 314 of the stator coil 34.

### (Arrangement of Lundel Type Rotor Core and Stator Core)

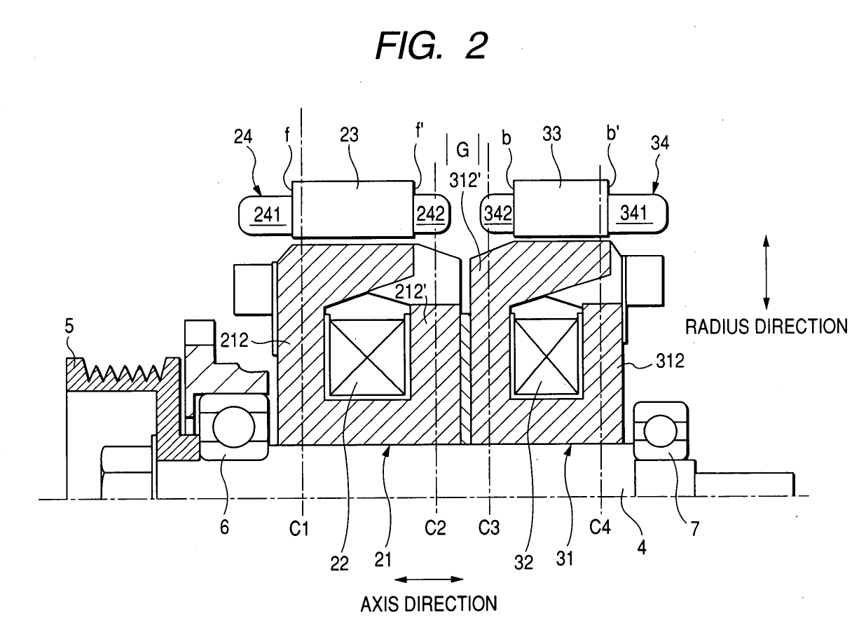

Hereinafter, a description will be given of the arrangement of the Lundel type rotor core (Lundel type field iron core) and the stator core (armature iron core) in the tandem vehicle alternator of the first embodiment according to the present invention with reference to FIG. 2.

FIG. 2 is an axially sectional view that mainly shows a pair of the electric generators (as dual electric power generation units) placed in the tandem vehicle alternator of the first embodiment shown in FIG. 1. The housing 1 is omitted from FIG. 2 in order to clearly show the structure of the rotors and the armatures in the tandem vehicle alternator shown in FIG. 1.

In FIG. 2, the disk parts 212 and 312 will be referred to as inside disk parts, and similarly, the outside disk parts 212′ and 312′ will be referred to as outside disk parts.

In FIG. 2, reference character C1 designates a center position of the inside disk part 212 of the Lundel type rotor core 21 in the axial direction, and C2 denotes a center position of the outside disk part 212′ of the Lundel type rotor core 21 in the axial direction. Reference character C3 designates a center position of the outside disk part 312′ of the Lundel type rotor core 31 in the axial direction, and C4 denotes a center position of the inside disk part 312′ of the Lundel type rotor core 31 in the axial direction.

In the first embodiment as clearly shown in FIG. 2, the center position C1 of the inside disk part 212 in the axis direction is placed at the rear of the front end surface f of the stator core 23, and the center position C2 of the outside disk part 212′ in the axis direction is placed at the front of the rear end surface f′ of the stator core 23. Further, the center position C3 of the outside disk part 312′ in the axis direction is placed at the front of the front end surface b of the stator core 33, and the center position C4 of the inside disk part 312 in the axis direction is placed at the front of the rear end surface b′ of the stator core 33.

That is, the stator core 23 (armature core) is placed at the front area to the position of the Lundel type rotor core 21 and the stator core 33 (armature core) is placed at the rear area to the position of the Lundel type rotor core 31 in the tandem vehicle alternator according to the first embodiment when compared with the case of an ordinary vehicle alternator.

It is thereby possible to shift the coil end 242 in a pair of the coil ends 241 and 242 of the stator coil 24 toward the front direction within a range unless the stator coil 24 is not contacted to the inner surface of the front end part of the housing 1 (see FIG. 1). Similarly, it is thereby possible to shift the coil end 342 in a pair of the coil ends 341 and 342 of the stator coil 34 toward the rear direction within a range unless the stator coil 34 is not contacted to the inner surface of the rear end part of the housing 1. (see FIG. 1)

As shown in FIG. 1, the position of the inner surface of the front end part and the position of the inner surface of the rear end part of the housing 1 in the axis direction are determined in substance by the position of the bearings 6 and 7 in the axis direction. The position of each of the bearings 6 and 7 in the axis direction is substantially determined by the length of each of the Lundel type rotor cores 21 and 31 in the axis direction.

In the first embodiment, the stator coils 24 and 34 are composed of sequential segment joining type stator coils that have been well known. For example, conventional patent documents such as following Japanese patent documents (2)Japanese patent No. 3118837, (3)Japanese patent No. 3178468; and (4)Japanese patent No. 3199068. The explanation of the configuration of the stator coils 24 and 34 are thereby omitted here. Each phase winding of a multi-phase stator coil is formed by sequentially connecting the front tip parts of letter U segment electrical conductors that project toward the coil end part. It is thereby possible to reduce each length along the axis direction of the coil ends 241 and 242 of the stator coil 24 wound around the stator core 23 when compared with that of the stator coil in an ordinary wound type vehicle alternator. It is also possible to reduce each length along the axis direction of the coil ends 341 and 342 of the stator coil 34 wound around the stator core 33 when compared with that of the stator coil in an ordinary wound type vehicle alternator.

It is thereby possible to place the stator core 23 at the front part without contacting the front end part of the coil end 24 with the front housing 11, and also possible to place the stator core 33 at the rear part without contacting the tip end part of the coil end 341 with the rear housing 13.

By the way, it is necessary to place the stator core 23 at the front part within a range so that the front end surface of the stator core 23 is not positioned in front of the front end surface of the Lundel type rotor core 21 in order to keep the magnetic flux flowing between the stator core 23 and the Lundel type rotor core 21. Similarly, it is also necessary to place the stator core 33 at the rear part within a range so that the rear end surface of the stator core 33 is not positioned in front of the rear end surface of the Lundel type rotor core 31 in order to keep the magnetic flux flowing between the stator core 33 and the Lundel type rotor core 31.

The tandem vehicle alternator of the first embodiment according to the present invention having the configuration described above has following effects.

As can be understood from the configuration of the tandem vehicle alternator according to the first embodiment as shown in FIG. 2, it is possible to place the coil end 242 at the inner side along the axis direction at the front part of the stator core 23 and also possible to place the coil end 342 at the inner side along the axis direction at the rear part in the position of the stator core 33 by the reduction along the axis direction of each coil end. This feature can be obtained by using the sequential segment joining type stator coils. Accordingly, this configuration can increase a gap G (see FIG. 2) along the axis direction between the coil ends 242 and 342 without increasing the length of the housing 1 in its axis direction. The increase of the gap G along the axis direction can decrease the mutual thermal influence between the coil ends 242 and 342, the temperature of which increase during the operation of the tandem vehicle alternator, and thereby prevent the temperature rise of the coil ends 242 and 342. As apparently from FIG. 1, because it is difficult to efficiently cool the coil ends 242 and 342 placed at the inner side along the axis direction when compared with the coil ends 241 and 341, increasing the gap G becomes an important feature of cooling the coil ends 242 and 342 in the tandem vehicle alternator.

Further, it is possible to reduce an induced voltage generated by changing the current flowing through the opposite coil end in the coil ends 2424 and 342 because of reducing the magnetic connection, namely, the mutual inductance between the coil ends 242 and 342 by increasing the gap G in the axis direction. It is thereby possible to increase the independency of controlling each of the stator coils 24 and 34.

In the configuration of the tandem vehicle alternator according to the first embodiment, each of the coil end 241 and the coil end 341 placed at the axial outer part of the stator coils 24 and 34 will be referred to as a leg part coil end, and each of the coil end 242 and the coil end 342 placed at the axial inner part of the stator coils 24 and 34 will be referred to as a head part coil end. It is thereby possible to further reduce the gap G in the axis direction. For more detailed explanation, each of the stator coils 24 and 34 is made of the plural letter U shaped segment electrical conductors, namely, has the head part of and the leg part of the letter U shaped segment electrical conductors, and the former is referred to as “the head coil end” and the latter is referred to as “the leg coil end”.

Because of having the necessity of joining the tip end parts of the leg parts of the letter-U-shaped segment electrical conductors, the leg coil end has a larger length along the axis direction than that of the head coil end. Accordingly, it is possible to further increase the gap G in the axis direction by forming each of the coil ends 242 and 342 placed at the inner side of the stator cores 24 and 34 along the axis direction by using the head coil end of the stator coil made of the plural sequential segment joining type stator coils.

### (Permanent Magnets 25 and 35 Arranged Between Claw Poles)

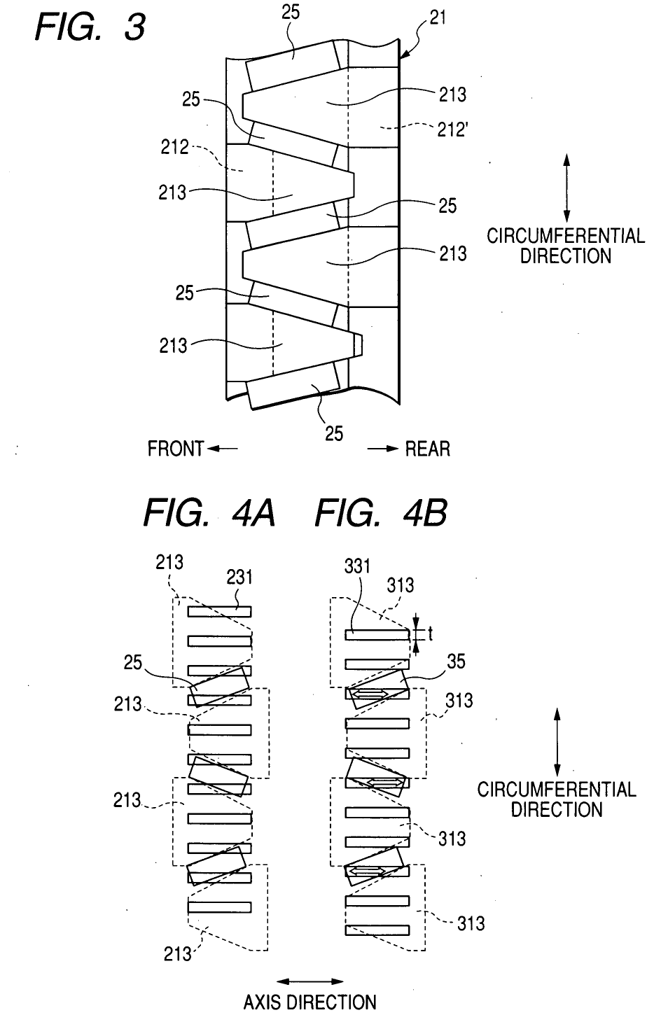

In the first embodiment, as shown in FIG. 1, each permanent magnet 25 is arranged between the adjacent claw poles 213 and 213 and between the adjacent claw poles 313 and 313 placed in the circumferential direction of the respective Lundel rotor cores 21 and 31. FIG. 3 shows the arrangement of the permanent magnets 25 in the Lundel rotor core 21. That is, FIG. 3 is a partial extended elevation of the Lundel rotor core in the tandem vehicle alternator observed from the direction toward the center of the rotor core.

In the first embodiment, because each of the claw poles 213 and 313 that protrudes toward the outside of the axial direction from each of the outside disk parts 212′ and 312′ reaches the outside area of each of the inside disk parts 212 and 312 in the radial direction, the permanent magnets 25 and 35 reach the outside area of the inside disk parts 212 and 312 in the radius direction. That is, the front part of the permanent magnet 25 protrudes in front of the rear part of the inside disk part 212, and the rear end of the permanent magnet 35 protrudes to the rear part of the front end of the inside disk part 312. It is thereby possible to reduce magnetic flux leakage between the claw poles 313 adjacent in the circumferential direction, and to further suppress magnetic flux leakage between the inside disk parts 212 and 312, and the claw poles 213 and 313. That is, it is possible to enhance the field magnetic flux and to increase the output of the tandem vehicle alternator because of suppressing the magnetic flux leakage to be generated between the each surface of the claw poles 213 and 313 faced to the circumferential direction, and each surface of the inside disk parts 212 and 312 placed in the radius direction.

### (Shape of Each of Teeth 231 and 331)

In the tandem vehicle alternator according to the first embodiment of the present invention, the width of the front tip surface of each tooth along the circumferential direction at the inside of the stator core (armature iron core) 23 in the radius direction is formed narrower than the width of the permanent magnet 25 along the circumferential direction, and the width of the front tip end surface of each tooth along the circumferential direction at the inside of the stator core (armature iron core) 33 in the radius direction is formed narrower than the width of the permanent magnet 35 along the circumferential direction.

FIG. 4A is a partial extended elevation of the stator core 23 in the tandem vehicle alternator shown in FIG. 1. FIG. 4B is a partial extended elevation of the stator core 33 in the tandem vehicle alternator shown in FIG. 1. In FIG. 4A, reference number 231 designates the teeth of the stator core 23, and reference character “t” indicates the width along the circumferential direction. In FIG. 4B, reference number 331 designates each tooth of the stator core 33, and reference character “t” indicates the width of each tooth 331 along the circumferential direction.

It is possible to eliminate or prevent the flow of a short magnetic flux at the front end surface of the tooth in the radius direction when the front tip end surface of the teeth 231 and 331 at the inside along the radius direction crosses the placement area of the permanent magnets 25 and 35 along the circumferential direction. It is, thereby possible to increase the output of the tandem vehicle alternator of the first embodiment by the amount of the short magnetic flux.

### COMPARATIVE EXAMPLE

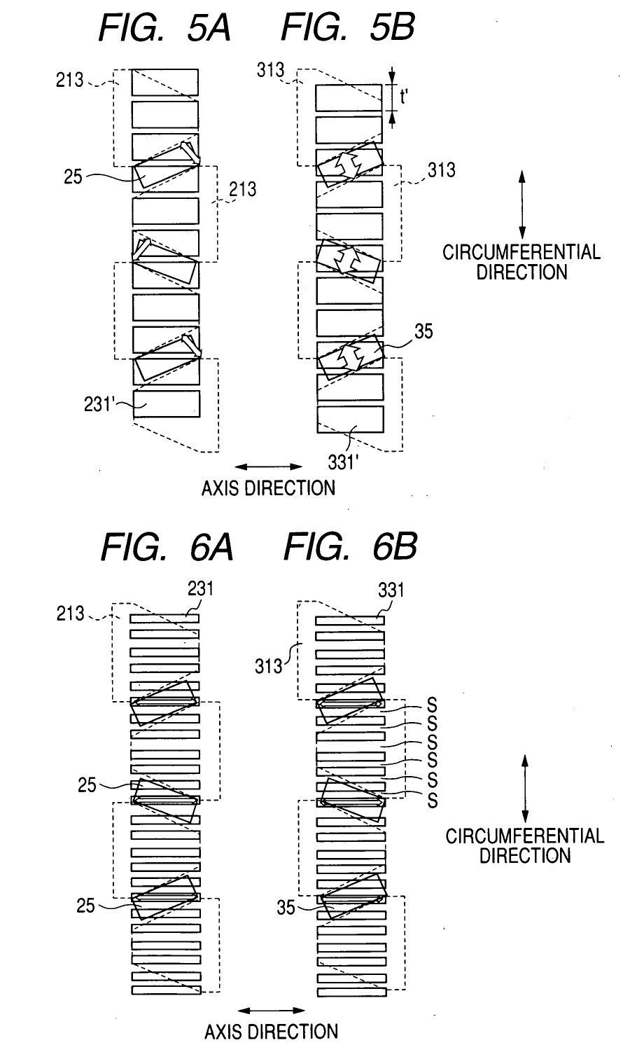

FIG. 5A is a partial extended elevation of a stator core in a vehicle alternator as a comparative example. FIG. 5B is a partial extended elevation of the other stator core in the vehicle alternator as the comparative example.

The vehicle alternator as the comparative example shown in FIG. 5A and FIG. 5B has the teeth 231′ and 331′ of a pair of the stator cores (armature iron cores) 23 and 33 in which the width of the front tip end surface of each tooth along the circumferential direction at the inside in the radius direction is formed greater than the width of each of the permanent magnets 25 and 35 along the circumferential direction. In FIG. 5B, reference character t′ designates the width of each of the teeth 231′ and 331′ along the circumferential direction. In this case, it is understood to cause a short circuit between a north (N) pole and a south (S) pole of each of the permanent magnets 25 and 35 generated at a pair of side surfaces toward an approximate circumferential direction of the permanent magnet through the front tip end surface of each of the teeth 231′ and 331′ at the inside in the radius direction.

In FIGS. 4A, 4B, 5A, and 5B, each arrow indicates the direction of the magnet flux leakage of the permanent magnets 25 and 35, and the size of the arrow indicates an amount of the magnet flux leakage, the length of the arrow denotes a magnetic path length. FIGS. 5A and 5B show the arrows of different sizes which correspond to a different gap length of each part in the permanent magnets 25 and 35 caused by a slant of the permanent magnet.

As can be understood from FIGS. 4A and 4B, when the width of the front tip end surface of each of the teeth 231 and 331 along the circumferential direction at the inside in the radius direction becomes narrow, the occupation rate of the teeth 231 and 331 in the circumferential surface of the stator core 23 and 33 is reduced. This decreases the amount of the field magnet flux flowing from the Lundel rotor cores 21 and 31 to the stator cores 23 and 33, and the output of the vehicle alternator is thereby decreased.

It is possible to solve such a decrease of the output by increasing the number of slots per pole and per phase as shown in FIGS. 6A and 6B when compared with the configuration of the slots shown in FIGS. 4A, 4B, 5A, and 5B. FIG. 6A is a view showing a deformation example of the stator core in the vehicle alternator shown in FIG. 1. FIG. 6B is a view showing a deformation example of the stator core in the vehicle alternator shown in FIG. 1. In FIGS. 6A and 6B, reference character S designates a slot of the stator core.

### (Line Groove Structure of Claw Poles 213 and 313)

When the number of the permanent magnets 25 and 35 and the teeth 231 and 3331 is increased, the amount of an eddy current increases at the outer circumferential surface of the claw poles 213 and 313, and the eddy current loss is thereby increased, and the temperature of the field coil is increased by the thermal transmission from the claw poles 213 and 313.

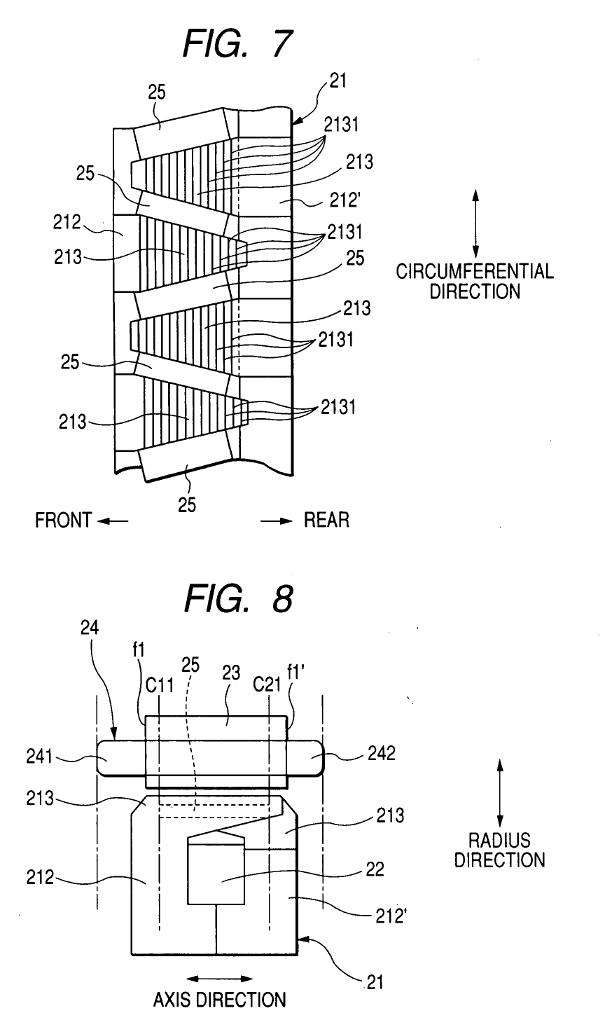

The problem can be solved by forming plural grooves 2131 on the surface of each claw pole 213 in the Lundel type rotor core 21 in order to extend the total length of the current path of the eddy current, as shown in FIG. 7. FIG. 7 is a view showing an example of line-shaped concave grooves formed on the surface of each claw pole having the configuration shown in FIG. 3. The line shaped grooves are also formed on the surface of each claw pole 313 of the Lundel type rotor core 31.

In FIG. 7, a depth of the line-shaped groove 2131 is approximately equal to the width of a gap or gap length between the claw pole 213 and the stator core 23. However, it is acceptable to change the gap length within a specified range unless the flow of the field magnetic flux is prevented.

It is preferred to decrease the width of each line-shaped concave groove 2131 as narrow as possible in order to prevent the amount of the magnetic flux flowing from the claw poles 213 and 313 to the teeth 231 and 331. It is also preferred to reduce the pitch of the line-shaped concave grooves 2131 than the width of the teeth 231 of the stator core 23 along the circumferential direction. This can enhance the effect obtained by extending the flow path of the eddy current. In this case, it is preferred to form the depth of each groove 2131 as large as possible unless the flow of the field magnetic flux is prevented.

Although it is preferred that the direction of extending the line-shaped concave grooves 2131 formed in parallel to each other on the surface of each claw pole is intersected at the right angle of the flow of the eddy current, it is not limited by this condition as shown in FIG. 7, for example. Further, it is acceptable to form a curve-shaped groove instead of the line-shaped concave groove 2131.

The use of the curve-shaped groove can increase the magnetic flux density between the claw poles 213 and 313 and the stator cores 23 and 33, and thereby decrease the eddy current loss on the outer peripheral surface of the claw poles 213 and 313 and suppress the increase of the temperature of the field magnetic coil even if the number of the teeth 231 and 331.

### (Experimental Result)

A conventional vehicle alternator has a single electric power generation unit of 2.5 kw having an outer diameter of 143 mm and a longitudinal length or an axial length of 140 mm. On the contrary, the tandem vehicle alternator having the configuration described above according to the first embodiment has a pair of the electric power generation units of 2.5 kw, and each unit has an outer diameter of 143 mm and an axial length of 140 mm. That is, the tandem vehicle alternator of the first embodiment of the present invention has a pair of the electric power generation units that can be controlled independently without increasing the size of the vehicle alternator, namely, increasing the outer diameter and the axial length of the vehicle alternator when compared with the size of the conventional vehicle alternator.

### Second Embodiment

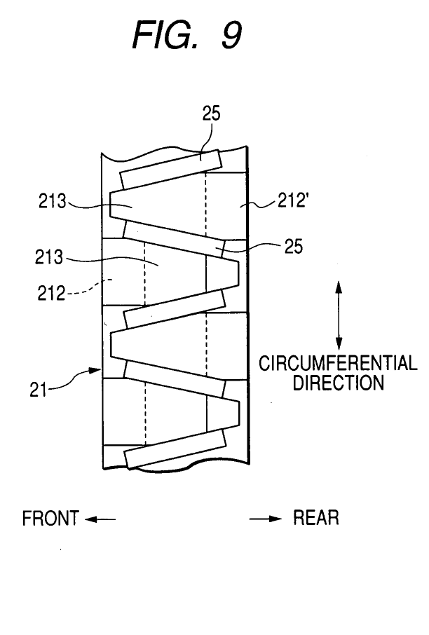

A description will be given of the configuration and the feature of the tandem vehicle alternator according to the second embodiment of the present invention with reference to FIG. 8 and FIG. 9.

FIG. 8 is a schematic sectional view of the vehicle alternator equipped with a single electric power generation unit composed mainly of a Lundel type rotor core and an armature according to the second embodiment of the present invention. FIG. 9 is a partial extended elevation of the Lundel rotor core observed from the direction toward the center point of the Lundel rotor core shown in FIG. 8.

The vehicle alternator according to the second embodiment has the single electric power generation unit that is different in configuration from the tandem vehicle alternator having a pair of the electric power generation units of the first embodiment shown in FIG. 1.

The first feature of the vehicle alternator according to the second embodiment is that the center position C11 of one disk part 212 in a pair of the disk parts of the Lundel type rotor core 21 in the axis direction is placed at the rear of the front end surface f1 of the stator core 23, and the center position C21 of the other disk part 212′ in a pair of the disk parts of the Lundel type rotor core 21 in the axis direction is placed in the front of the rear end surface f1′ of the stator core 23. That is, the center position of each of the disk parts 212 and 212′ is placed at the inside position of the stator core 23. This configuration of a pair of the disk parts of the Lundel type rotor core can reduce the axial length of the Lundel type rotor core in the axis direction.

The stator coil 24 is composed of the sequential segment joining type stator coils, like the configuration of the stator coil 24 of the first embodiment. It is thereby possible to reduce the length of the coil ends 241 and 242 of the stator coil 24 in the axis direction.

Further, in the second embodiment, the permanent magnets 25 are placed between the adjacent claw poles in the circumferential direction, and each claw pole 213 reaches the each outside area of the inside disk part 212 and 212′ in the radius direction, and each permanent magnet 25 reaches the outside of the inside disk parts 212 and 212′ in the radius direction. It is thereby possible to prevent the occurrence of the magnet flux leakage between the claw poles 213 and the inside disk parts 212 and 212′.

Still further, like the configuration of the first embodiment, it is acceptable to have the same feature of the first embodiment in which the width of the front tip end part of each tooth of the stator core (as the armature iron core) 23 along the circumferential direction at the inside in the radius direction is narrower than the width of the permanent magnet 25 in the circumferential direction as narrow as possible. That is, the various features of the configuration of the tandem vehicle alternator according to the first embodiment can be applied to various type vehicle alternators such as an ordinary type vehicle alternator with the same effects and action.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A vehicle alternator comprising a pair of electric power generation units adjacently placed in an axis direction, each electric power generation unit comprising:
a Lundel type field winding fixed to a same rotary shaft of the vehicle alternator, comprising:
a boss part;
a pair of disk parts faced to each other formed on the boss part; and
an even number of claw poles alternately forming a north pole and a south pole on each disk part,
and
an armature comprising:
a cylindrical armature iron core, placed at the outside of the claw poles along the radius direction, having an armature winding which is wound around the cylindrical armature iron core and is composed of plural letter-U-shaped segment electrical conductors,
wherein in each electric power generation unit, a center position of an inside disk part, as one disk part in a pair of the disk parts, placed at the outside of the axis of the Lundel type field winding is placed within a width of the cylindrical armature iron core observed from the axial direction thereof.

2. A vehicle alternator comprising a pair of electric power generation units adjacently placed in an axis direction, each electric power generation unit comprising:
a Lundel type field winding fixed to a same rotary shaft of the vehicle alternator and forming a tandem type rotor; and
an armature,
wherein the Lundel type field winding comprises:
a boss part composed of a cylindrical iron core fixed to the rotary shaft of the vehicle alternator and on an outer surface of the boss part a field winding is wound;
a pair of disk parts faced to each other, each disk part being composed of a ring plate iron core extending from an end of the boss part toward an outside direction in the radius direction; and
an even number of claw poles faced to each other, extending toward the axis direction from an outer end part of each disk part in the radius direction and alternately forming a north pole and a south pole,
and the armature comprises a cylindrical armature iron core fixed to a housing of the vehicle alternator, around the cylindrical armature iron core an armature winding being wound, and placed at the outside of the claw poles along the radius direction, in which the armature winding is composed of plural letter-U-shaped segment electrical conductors and each conductor is inserted through one side of a pair of slots arranged in the axis direction and sequentially connected to each other,
wherein one disk part in a pair of the disk parts forms an inside disk part, and a center position of the inside disk part observed from the axial direction is placed within a width of the cylindrical armature iron core observed from the axial direction of the cylindrical armature iron core, and the inside disk part of each electric power generation unit is placed at the outside of the axis of the tandem type rotor.

3. The vehicle alternator according to claim 2, wherein the other disk part in a pair of the disk parts is an outside disk part whose center position in the axis direction is placed at the outside of the width of the cylindrical armature iron core observed from the axial direction of the cylindrical armature iron core and placed at the inside of the axis of the tandem type rotor.

4. The vehicle alternator according to claim 3, wherein a permanent magnet is placed in a gap along the circumference direction between each claw pole extending from the inside disk part and the claw pole extending the outside disk part and the permanent magnet is magnetized in order to enhance a magnetic force of the claw pole.

5. The vehicle alternator according to claim 4, wherein a width of a front tip end surface of each tooth along the circumferential direction at the inside in the radius direction of the cylindrical armature iron core is narrower than a width of the permanent magnet along the circumferential direction.

6. The vehicle alternator according to claim 5, wherein each phase has a plurality of the slots in the cylindrical armature iron core.

7. The vehicle alternator according to claim 6, wherein plural line-shaped concave grooves are formed at a specified pitch on an outer peripheral surface of each claw pole.

8. A vehicle alternator comprising a Lundel type field winding and an armature, wherein
the Lundel type field winding comprises:
a boss part composed of a cylindrical iron core fixed to a rotary shaft of the vehicle alternator, and on an outer surface on which a field winding is wound;
a pair of disk parts faced to each other, each disk part being composed of a ring plate iron core extending from an end of the boss part toward an outside direction in the radius direction; and
an even number of claw poles, faced to each other and alternately forming a north pole and a south pole, extending toward the axis direction from an outer end part of each disk part placed in the radius direction,
and the armature, comprises:
a cylindrical armature iron core fixed to a housing of the vehicle alternator, around the cylindrical armature iron core an armature winding being wound, and placed at the outside of the claw poles along the radius direction; and
permanent magnets magnetized in order to enhance a magnetic force of the claw poles, each of the permanent magnets is placed at a gap between the claw poles adjacent to each other-in the circumferential direction, and
at least one of a pair of the disk parts forms an inside disk part, and a center position of the inside disk part observed from the axial direction is placed within a width of the cylindrical armature iron core observed from the axial direction of the cylindrical armature iron core.

9. The vehicle alternator according to claim 8, wherein the armature winding is composed of plural letter-U-shaped segment electrical conductors and each letter-U-shaped segment electrical conductor is inserted through one side of a pair of slots arranged in the axis direction and sequentially connected to each other.

10. The vehicle alternator according to claim 9, wherein each permanent magnet is placed in extending toward the outside of the inside disk part in the radius direction.

11. The vehicle alternator according to claim 10, wherein a center position of each axis of a pair of the disk parts is within a width of the cylindrical armature iron core observed from the axial direction of the cylindrical armature iron core.

12. The vehicle alternator according to claim 11, wherein a width of a front tip end surface of each tooth along the circumferential direction at the inside in the radius direction of the cylindrical armature iron core is narrower than a width of the permanent magnet along the circumferential direction.

13. The vehicle alternator according to claim 12, wherein each phase has a plurality of the slots in the cylindrical armature iron core.

14. The vehicle alternator according to claim 13, wherein plural line-shaped concave grooves are formed at a specified pitch on an outer circumferential surface of each claw pole
